(19) United States
(12) Patent Application Publication
(10) Pub. No.: US 2007/0080665 A1
(43) Pub. Date: Apr. 12, 2007

(54) System and method for monitoring power supplied to a battery

(76) Inventors: Christopher R. Paul, Bayport, NY (US); Joseph Cabana, Centereach, NY (US); Giovanni Ritieni, Patchogue, NY (US)

Correspondence Address: FAY KAPLUN & MARCIN, LLP, 15O BROADWAY, SUITE 702, NEW YORK, NY, 10038, US

(21) Appl. No.: 11/193,662

(22) Filed: Jul. 29, 2005

(51) Int. Cl. H02J 7/00

(52) U.S. Cl. 320/128

(57) ABSTRACT

Described is a method of supplying power to recharge a battery and drive at least one load separate from the battery, wherein the load is connected to the battery. A current amount supplied to only the battery is determined. A battery voltage is determined. Power is disabled to the battery when the current amount is less than a predetermined current termination threshold and the battery voltage is greater than or equal to a voltage limit.

### BACKGROUND

A conventional wireless device typically utilizes a renewable power source, such as a rechargeable battery (e.g., a lithium-ion battery) to enhance portability of the device. The lithium-ion battery has proven to be very efficient in terms of power and voltage output. Thus, the lithium-ion batteries are utilized by, for example, portable computers, portable computer peripherals, personal digital assistants (PDAs), digital cameras, camcorders, wireless headsets and cellular phones.

A limitation inherent in use of the battery is a limited charge held by the battery. That is, the battery must be recharged when it has been completely or nearly completely discharged. However, the overall life-span of the battery may be shortened if left to charge after it has reached a full capacity. Overcharging may cause further damage and/or swelling, which reduces the life-span of the battery and an ability to maintain a charge.

A conventional charging device utilizes a timer and/or a current detection mechanism to determine whether a current accepted by the battery has fallen below a preset current termination threshold. However, conventional charging devices do not recognize when the battery is subjected to a load while charging. The load may be the result of, for example, use of a transceiver (e.g., a WAN/LAN radio)and/or a backlight. Thus, the current supplied by the charging device is split indeterminately between the load and the battery. The timer will not guarantee that the battery is fully charged because a portion of the power meant for the battery may have been stolen by the load. Similarly, the load may prevent the current provided by the charger from ever falling below the current termination threshold. Thus, even when the battery is fully charged, the charging device will sustain the power supplied to the battery because of the presence of the load. Therefore, it is desirable to detect when the battery has been charged to the full capacity in the presence of the load.

### SUMMARY OF THE INVENTION

A method of supplying power to recharge a battery and drive at least one load separate from the battery, wherein the load is connected to the battery. A current amount supplied to only the battery is determined. A battery voltage is determined. Power is disabled to the battery when the current amount is less than a predetermined current termination threshold and the battery voltage is greater than or equal to a voltage limit.

A device having a power supply circuit to supply power to a battery and at least one load separate from the battery, herein the load is connected to the battery. A circuit to compare a current amount supplied to only the battery to a predetermined current termination threshold and a battery voltage to a voltage limit and a disabling circuit to terminate the power when the current amount is less than the predetermined current termination threshold and the battery voltage is one of greater than and equal to the voltage limit.

A method for receiving a first indication of a current amount corresponding to a charge being supplied to only a battery, comparing the current amount to a current termination threshold, receiving a second indication of a battery voltage and disabling power to the battery when the current amount is less than the current termination threshold and the second indication that the battery voltage has reached a battery threshold voltage.

### BRIEF DESCRIPTION OF THE DRAWINGS

FIG. 1 shows a first typical arrangement for recharging a rechargeable battery according to the present invention.

FIG. 2 shows a second typical arrangement for recharging a rechargeable battery according to the present invention.

FIG. 3 shows an exemplary embodiment of a method for detecting whether a battery charge is complete according to the present invention.

FIG. 4 shows a block diagram of a first exemplary circuit which may be used to implement the method of FIG. 3 for determining whether a battery has been fully charged according to the present invention.

FIG. 5 shows a block diagram of a second exemplary circuit which may be used to implement the method of FIG. 3 for determining whether a battery has been fully charged according to the present invention.

FIG. 2 shows an exemplary embodiment of a system for charging a battery according to the present invention.

FIG. 3 shows an exemplary embodiment of a battery pack according to the present invention.

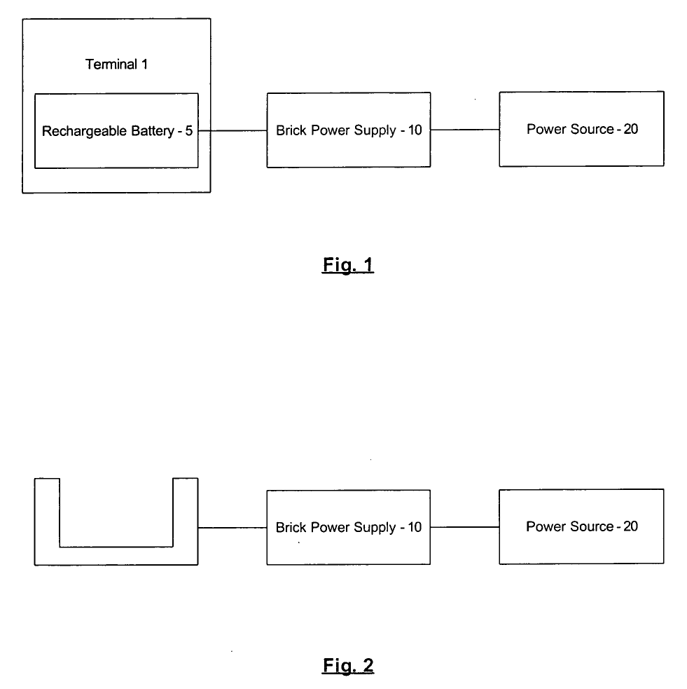

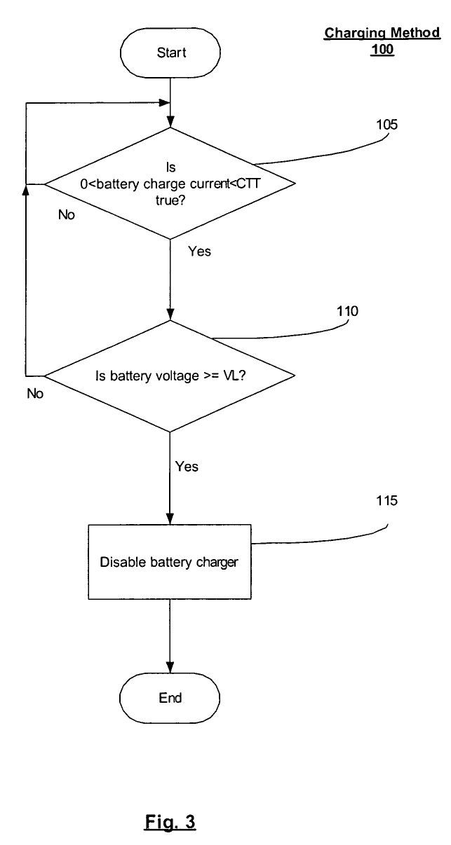

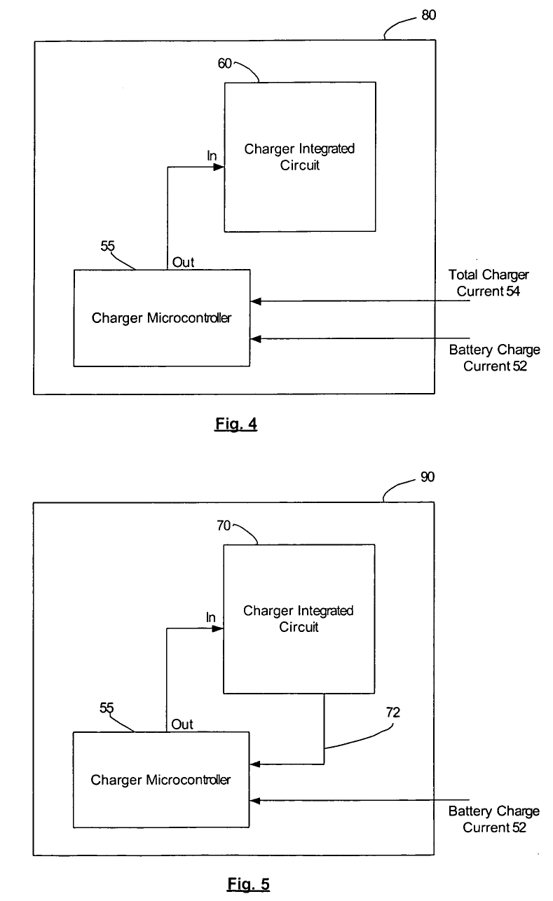

FIG. 4 shows an exemplary embodiment of a circuit for a power supply arrangement according to the present invention.

FIG. 5 shows another exemplary embodiment of a circuit for a power supply arrangement according to the present invention.

### DETAILED DESCRIPTION

The present invention may be further understood with reference to the following description and the appended drawings, wherein like elements are referred to with the same reference numerals. The exemplary embodiments of the present invention are described with reference to a lithium ion cell and a lithium ion cell charger. However, those of skill in the art will understand that the present invention may be applied to any type of rechargeable battery and battery charger.

FIG. 1 shows a first typical arrangement for recharging a rechargeable battery 5. In this arrangement, the rechargeable battery 5 is included as part of a terminal 1 that may be, for example, a PDA, a cell phone, a scanner (e.g., a laser-based scanner, an image-based scanner), etc. The rechargeable battery 5 may be a removable or non-removable part of the terminal 1.

The terminal 1 is shown as being connected to a brick power supply 10 which is, in turn, connected to a power source 20. The brick power supply 10 converts incoming AC power (from power source 20) to a regulated DC supply that is used by a charger IC within the terminal to recharge the rechargeable battery 5 of terminal 1. Those of skill in the art will understand that battery chargers may come in many different embodiments and the present invention is not limited to any particular battery charger.

The power source 20 may be any source of AC power such as a wall outlet, but may also be a regulated or unregulated DC power source. In such a case, the brick power supply will convert the incoming DC power to the regulated DC supply that is used by a charger IC within the terminal to charge the battery 5. The connections between the terminal 1, brick power supply 10 and power source 20 may be a wired connection with suitable connectors as is well known in the art.

FIG. 2 shows a second typical arrangement for recharging a rechargeable battery. Similar to the arrangement of FIG. 1, the arrangement of FIG. 2 includes a power supply 20 and a brick power supply 10 to supply regulated DC power to a charger IC in a terminal for recharging a rechargeable battery. However, in this arrangement, the brick power supply 10 is connected to a cradle 30. The terminal 1 of FIG. 1 may be placed in the cradle 30 to recharge the battery 5 of the terminal. The cradle 30 will include appropriate connectors to make electrical contact between the cradle 30 and the terminal 1/battery 5. In an alternative embodiment, the rechargeable battery 5 may be removable from the terminal 5 and separately insertable into the cradle 30 equipped with a charger IC for recharging.

Those of skill in the art will understand that the arrangements of FIGS. 1 and 2 are only provided for illustrative purposes and that the exemplary methods of the present invention may be applied to any type of recharging arrangement for a rechargeable battery.

A typical charger for a battery (e.g., a lithium-ion cell charger) is essentially a current limited, voltage limited energy source. The charger output will not exceed a voltage limit (“VL”) for the cell (e.g., typically 4.2V for a lithium ion cell) and the charger current limit (“CL”) is typically set by a user in accordance with the cell manufacturer's specifications. Other considerations such as charging time may also be used to set the CL. A cell which is fully or nearly discharged will charge at a constant CL amps until it reaches the VL. Thereafter, the charger maintains a constant VL across the battery. After switching to the constant voltage mode, the current drawn by the cell will fall from a maximum of CL amps until charging is completed. Thus, a typical charger may be considered to have two modes of operation: I) a constant current (“CC”) mode; and ii) a constant voltage (“CV”) mode.

If the charger is supplying current to the battery only, it is fairly easy to determine whether the battery is fully charged by measuring the charger current. However, if there is also a load (e.g., a LAN/WAN radio, etc.) present and connected to the battery during the charging, the charger current measurement is not sufficient to determine whether the battery is fully charged. For example, terminal 1 of FIG. 1 may include a display screen which the user desires to remain on during the time that the battery 5 is charging. Thus, the display screen and the battery 5 will be drawing power from the brick power supply at the same time through the same charging circuit, i.e., the battery and the extra load (display screen) are inseparable loads. The exemplary embodiments of the present invention are directed at determining whether a battery is fully charged when there is also a load present during charging. As described above, knowing whether the battery is fully charged is important to avoid overcharging which results in a reduced life span of the battery.

When a load is present during charging, there are several different scenarios which may occur. These different scenarios illustrate the need for more information than just the charger current for determining whether the battery is fully charged. For example, in a first scenario the charger is in CC mode and the battery charge current is less than a current termination threshold (“CTT”) because the load is drawing almost the entire CL (or even more). In a second scenario, the charger is in CC mode and the battery charge current is more than the CTT because the load is not as severe as in the first scenario. In a third scenario, the charger is in CV mode and the total current is less than CL. In this scenario, the battery current may be more or less than the CTT depending on the load current. Finally, in a fourth scenario, the charger is in CV mode and the current drawn by the battery and the load is less than CTT.

Those of skill in the art will understand that the above scenarios are only exemplary and there may be other charging scenarios or variations of these scenarios that exist. The present invention may be equally applied during these other and/or varying scenarios. The above described scenarios are used to illustrate the need for more than one current to determine whether the battery is fully charged.

FIG. 3 shows an exemplary method 100 illustrating a determination of whether a battery is fully charged. In step 105, it is determined whether the battery charge current is between 0 and the CTT. Exemplary manners of determining the battery charge current will be described below. If the battery charge current is not within this range, the battery is not fully charged and the process loops and continues to monitor the battery charge current.

In step 110, it is determined whether the battery voltage is greater than or equal to VL or less than VL. Exemplary manners of determining the battery voltage will be described below. If the battery voltage is less than VL, the battery is not fully charged and the process loops and continues to monitor the battery charge current and voltage. If the battery voltage is greater than or equal to VL, the method continues to step 115 to disable the charger because the battery has been determined to be fully charged.

Thus, the method 100 shows that by determining the battery charge current and the battery voltage it is possible to determine whether the battery has been fully charged. Specifically, if the battery charge current is between 0 and CTT and the battery voltage is VL, the battery may be considered to be fully charged.

FIG. 4 shows a block diagram of a first exemplary circuit 80 which may be used to implement the method of FIG. 3 for determining whether a battery has been fully charged. Prior to describing the operation of the circuit 80, it should be understood that the circuit 80 is provided in block diagram and that while the components are shown as being enclosed in the block 80, there is no requirement that each of the described components are contained in the same physical device. For example, in one exemplary embodiment, all the components of the circuit 80 may be included as part of terminal 1, thereby allowing terminal 1 to be in complete control of the charging of battery 5 within terminal 1. In another exemplary embodiment, it may be possible to include one or more components of the circuit 80 in the brick power supply 10. In a further exemplary embodiment, it may be possible to provide a new interface between the brick power supply 10 and the terminal 1 that includes one or more components of the circuit 80. Thus, the description of the circuit 80 and the additional described exemplary circuits for implementing the exemplary method of the present invention are not limited to any particular physical embodiment. Those of skill in the art will understand that the functionality described herein may be implemented in numerous manners.

The circuit 80 is shown as including a charger microcontroller 55 and a charger integrated circuit (“IC”) 60. The charger microcontroller 55 may be any type of device or combination of hardware and/or software capable of processing data and/or accessing applications or logic functions, e.g., a processor, an application-specific integrated circuit (“ASIC”), etc. The charger microcontroller 55 is shown as receiving two inputs from current measuring circuits. The first input 52 is from a current measuring circuit measuring the battery charge current, i.e., the battery charger 10 current being supplied to the battery 5 for the purpose of recharging the battery 5. The second input 54 is from a current measuring circuit measuring the total current supplied by the battery charger 10, i.e., the battery current plus any load current.

The current measuring circuits (not shown) may be included as part of the terminal 1. The current measuring circuits may include current to voltage converters (e.g., transimpedance amplifiers). The output of the current measuring circuits may be input into analog-to-digital (A/D) converters (not shown) for input into the charger microcontroller 55. In an alternative embodiment, the output of the current measuring circuits may be input into analog comparators (not shown) having appropriate thresholds (described in more detail below). The output of the analog comparators may then be input into the charger microcontroller 55 digital inputs.

As described above with reference to step 105 of FIG. 3, a portion of the exemplary embodiment of the charging method is to determine whether the battery charge current is less than the CTT. As can be seen in the exemplary embodiment, the current input 52 is measuring this parameter (battery charge current) directly and inputting this value into the charger microcontroller 55 which may then compare the battery charge current to the CTT to determine whether the battery charge current is between 0 and the CTT as described above with reference to step 105. The CTT may be pre-programmed into the charger microcontroller 55 or set by the user. Thus, using this direct measurement of battery charge current provided by the current measuring circuit, the appropriate determination may be made with respect to the battery charge current and the CTT.

Those of skill in the art will understand that in the exemplary embodiment using comparators, the threshold value for the comparator on battery charge current may be set to CTT. Thus, the comparator may provide a first output when the battery charge current is greater than CTT and a second output when the battery charge current is less than CTT. The charger microcontroller 55 may distinguish between these two outputs to make the proper determination with respect to the battery charge current and the CTT.

As described above in the exemplary method 100 of FIG. 3, in addition to determining the battery charge current, it is also necessary to determine whether the battery voltage has reached VL (step 110) to conclude that the battery is fully charged. One manner of making this determination is to infer that the battery voltage has reached VL by determining whether the battery charger is operating in CV mode. Whether the battery charger is operating in CV mode may be inferred by determining whether the total charger current is less than CL.

As described above, the second input 54 into the charger microcontroller 55 is the total charger current as measured from a current measuring circuit which is included in, for example, the terminal 1. As previously described, the total charger current 54 may be greater than the battery charge current because the terminal 1 may have other loads (e.g., peripheral devices) that are operating in addition to the battery 5. The charger microcontroller 55 will receive the total charger current input 54 and compare this value to CL to determine whether the battery charger is operating in CV mode.

In a similar manner as described above for the battery charge current, the exemplary embodiments which include a comparator for the total charge current may include a threshold that is set to CL. The comparator may provide a first output when the total charger current is greater than or equal to CL and a second output when the total charger current is less than CL. The charger microcontroller 55 may distinguish between these two outputs to make the proper determination with respect to the total charger current and the CL.

Thus, if the charger microcontroller 55 determines that the battery charge current is between 0 and CTT and that the battery voltage is VL or greater (by determining the battery charger is in CV mode based on the total charger current being less than CL), the charger microcontroller 55 has determined that both conditions indicating a fully charged battery have been satisfied. Thus, the charger controller 55 may drive an output to the charger IC 60 to indicate that the battery charger should be disabled because the battery 5 is fully charged. Those of skill in the art will understand that the functionality to disable the battery charger may reside in the charger IC 60 or in some other disabling circuit of the battery charger or terminal 1.

FIG. 5 shows a block diagram of a second exemplary circuit 90 which may be used to implement the method of FIG. 3 for determining whether a battery has been fully charged. The circuit 90 includes the charger microcontroller 55 receiving the battery charge current 52 input as described with reference to the circuit 80 of FIG. 4. However, the circuit 90 is shown as also including a charger IC 70 which includes functionality to measure the total charger current. An example of such an IC is the Linear Technologies LTC 4061 chip which includes a Charge Current Monitor pin. The IC 70 includes an output pin which outputs an analog signal 72 equal to the total charger current. This analog signal is accepted by an analog to digital (“A/D”) input of the charger microcontroller 55 which can determine if the total charger current is less than CL. If it is determined that the total charger current is less than CL, it can be inferred, as described above, that the battery charger is in CV mode and therefore, a condition for determining whether the battery is fully charged is satisfied.

In another exemplary embodiment, the battery 5 may be a smart battery that includes a controller. As understood by those skilled in the art, the controller may be referred to as a “smart battery,” because the controller may monitor a status of the battery 5. One functionality of the controller may be to measure the battery charge current when the battery 5 is being charged. Thus, the measurement of the battery charge current may be performed by a smart battery itself and this current value may be sent to the charger microcontroller to be compared with the CTT to determine whether the battery charge current is between 0 and the CTT as described above with reference to step 105.

The above exemplary embodiments illustrate that there are multiple manners of measuring or inferring that the conditions defined in method 100 above may be satisfied. Those of skill in the art will understand that other manners of measuring or inferring may also be used to implement the present invention. For example, it may be possible to directly measure the battery voltage for the purpose of implementing this invention. It may be possible to measure the load current and subtract this load current from the charger current to obtain the battery charge current. It may be possible to include logic in the charger which indicates a switch from CC mode to CV mode, etc.

In addition, other circuit design practices may be implemented to improve the performance of the exemplary battery charging circuits. For example, because of noise and because the current of the additional loads may be dynamic, the battery charge current and the total charge current may be averaged before being processed in accordance with the logic described herein.

In another example, there may be a range of currents near CL where there may be some uncertainty as to whether the battery charger has actually switched to CV mode. Thus, the CL may be set to some fraction (e.g., 95%) of the maximum current CL to ensure that the circuit will never falsely conclude that it is in CV mode and thereby possibly falsely conclude that the battery is fully charged. However, this means that there could be times that the circuit falsely concludes that it is in CC mode when it is really in CV mode where the battery might be fully charged. To deal with this possibility, the charger circuit may also include a timer to prevent the charging circuit from charging forever if CL>I>0.95CL, or if there is another incorrect detection within the circuit. The timer may be set to terminate the charge at some time after the expected battery charge time, but before the charger could cause permanent damage to the battery. The timer may be reset each time the battery is connected to the charger.

The present invention has been described with reference to the exemplary embodiments herein. However, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
supplying power to recharge a battery and drive at least one load separate from the battery, wherein the load is connected to the battery;
determining a current amount supplied to only the battery;
determining a battery voltage; and
disabling the power to the battery when the current amount is less than a predetermined current termination threshold and the battery voltage is one of greater than and equal to a voltage limit.

2. The method of claim 1, wherein the battery is one of a lithium ion battery, a nickel cadmium battery and a nickel metal hydryde battery.

3. The method of claim 1, wherein the power supplied to the battery is one of a constant current and a constant voltage.

4. The method of claim 1, wherein the voltage limit is based on a type of the battery.

5. The method of claim 1, wherein the current amount is set by a user.

6. The method of claim 1, wherein the determining the battery voltage is only performed after it is determined that the current amount is less than the predetermined current termination threshold.

7. The method of claim 1, wherein the battery is included in a device and the at least one load is a component of the device.

8. The method of claim 1, wherein the determining the battery voltage includes determining whether a total charger current is one of greater than and equal to a current limit (CL).

9. The method of claim 1, wherein the current amount is determined by averaging measured amounts of current.

10. A device, comprising:
a power supply circuit to supply power to a battery and at least one load separate from the battery, herein the load is connected to the battery;
a circuit to compare a current amount supplied to only the battery to a predetermined current termination threshold and a battery voltage to a voltage limit; and
a disabling circuit to terminate the power when the current amount is less than the predetermined current termination threshold and the battery voltage is one of greater than and equal to the voltage limit.

11. The device of claim 10, wherein the battery is included in the device.

12. The device of claim 10, wherein the circuit includes one of a processor, a microcontroller and an application specific integrated circuit.

13. The device of claim 10, wherein the power supply circuit operates in one of a constant current mode and a constant voltage mode.

14. The device of claim 13, wherein the circuit determines that the battery voltage is one of greater than and equal to the voltage limit when the power supply circuit is operating in the constant voltage mode.

15. The device of claim 14, wherein the circuit determines the power supply circuit is operating in the constant voltage mode when a total charger current is less than a charger current limit.

16. The device of claim 10, wherein the circuit receives the current amount supplied to only the battery from a current measuring circuit.

17. The device of claim 16, wherein the current measuring circuit averages current measurements to determine the current amount.

18. The device of claim 10, further comprising:
a timer, wherein the disabling circuit terminates the power after a predetermined time threshold measured by the timer.

19. A method, comprising:
receiving a first indication of a current amount corresponding to a charge being supplied to only a battery;
comparing the current amount to a current termination threshold;
receiving a second indication of a battery voltage; and
disabling power to the battery when the current amount is less than the current termination threshold and the second indication that the battery voltage has reached a battery threshold voltage.

20. The method of claim 19, wherein the second indication of the battery voltage reaching the battery voltage threshold is an operating mode of a battery charger.

21. The method of claim 19, wherein the second indication of the battery voltage reaching the battery voltage threshold is an indication that a total charger current of a battery charger is below a current threshold.

22. The method of claim 19, wherein the indication of the battery voltage reaching the battery voltage threshold is a direct measurement of the battery voltage.

23. The method of claim 19, wherein the battery charging current is received from one of a controller circuit and a sensor circuit which are included in a battery pack for the battery.
